(19) United States
(12) Patent Application Publication
(10) Pub. No.: US 2015/0121470 A1
(43) Pub. Date: Apr. 30, 2015

(54) PEER-TO-PEER ONBOARDING OF INTERNET OF THINGS (IOT) DEVICES OVER VARIOUS COMMUNICATION INTERFACES

(71) Applicant: QUALCOMM Incorporated, San Diego, CA (US)

(72) Inventors: Eric James RONGO, Seattle, WA (US); Marcello Vincenzo LIOY, Mercer Island, WA (US)

(21) Appl. No.: 14/522,441

(22) Filed: Oct. 23, 2014

Related U.S. Application Data
(60) Provisional application No. 61/895,518, filed on Oct. 25, 2013.

(51) Int. Cl. H04L 29/06; H04L 12/24

(52) U.S. Cl. CPC H04L 63/10; H04L 41/0813; H04L 63/08; H04L 63/083
USPC 726/4

(57) ABSTRACT

The disclosure generally relates to apparatus and method for setting up or onboarding a first Internet of Things (IoT) device that has limited or no interfacing capability itself to connect to a network through a second IoT device in communication with the network, by sending a request to a second device in communication with the network and receiving permission to initiate communication with the network.

### CROSS-REFERENCE TO RELATED APPLICATIONS

The present Application for Patent claims the benefit of U.S. Provisional Application No. 61/895,518, entitled “PEER-TO-PEER ONBOARDING OF INTERNET OF THINGS (IOT) DEVICES OVER VARIOUS COMMUNICATION INTERFACES,” filed Oct. 25, 2013, assigned to the assignee hereof, and expressly incorporated herein by reference in its entirety.

### TECHNICAL FIELD

Various embodiments described herein generally relate to onboarding or setting up of various Internet of Things (IoT) devices with limited or no user interfaces on a network.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communications network (e.g., an ad-hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

Wi-Fi-based methods have been devised to allow a user to set up or “onboard” a device on a home or office Wi-Fi network. In a conventional Wi-Fi-based onboarding process, the user typically needs to go through the onboarding process for each device in order to connect multiple devices to the home or office network. Some user devices, however, may have limited or no user interface capability. For small devices with limited or no user interfaces, such as small appliances or light emitting diode (LED) light bulbs, conventional Wi-Fi-based onboarding processes may be complex and may require repeated manual onboarding of each device.

Accordingly, a need exists for a simplified onboarding process for devices that have limited or no user interface capability with limited or no user intervention.

### SUMMARY

The following presents a simplified summary relating to one or more aspects and/or embodiments associated with the mechanisms disclosed herein to allow a user device that needs to be connected to a home network but has limited or no user interface capability itself to request and receive permission to onboard from another user device that is already on the home network. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein to allow a user device that needs to be connected to a home network but has limited or no user interface capability itself to request and receive permission to onboard from another user device that is already on the home network in a simplified form to precede the detailed description presented below.

According to one exemplary aspect, a method of onboarding a device is provided, the method comprising: detecting a local peer device via an out-of-band communication that is compatible with the device; communicating with the local peer device to obtain a permission to join a secure network; receiving access information to access the secure network from the local peer device after an authority has approved the access; and accessing the secure network using the access information.

According to another exemplary aspect, a method for onboarding a device by a local peer device is provided, the method comprising: communicating, by the local peer device, with the device via an out-of-band communication that is compatible with the device; obtaining, by the local peer device, permission from an authority to allow the device to join a secure network; and transmitting, from the local peer device to the device, access information for the secure network after the authority has approved access to the secure network by the device.

According to another exemplary aspect, an Internet of Things (IoT) device is provided, the IoT device comprising: means for detecting a local peer device via one or more IoT communication interfaces; means for communicating with the local peer device to obtain a permission to join a secure network; means for receiving access information to access the secure network from the local peer device after an authority has approved the access; and means for accessing the secure network using the access information.

According to yet another exemplary aspect, a local peer device that is capable of communicating over one or more Internet of Things (IoT) interfaces and over one or more wireless interfaces other than an IoT interface is provided, the local peer device comprising: means for communicating with an IoT device via said one or more IoT interfaces compatible with the IoT device; means for obtaining permission from an authority to allow the IoT device to join a secure network; and means for transmitting to the IoT device access information for the secure network after the authority has approved access to the secure network by the IoT device.

Other objects and advantages associated with the mechanisms disclosed herein to allow an IoT device that needs to be connected to a home network but has limited or no user interface capability itself to request and receive permission to onboard by communicating with another IoT device that is already on the home network described herein will be apparent to those skilled in the art based on the accompanying drawings and detailed description.

### BRIEF DESCRIPTION OF THE DRAWINGS

A more complete appreciation of aspects of the disclosure and many of the attendant advantages thereof will be readily obtained as the same becomes better understood by reference to the following detailed description when considered in connection with the accompanying drawings which are presented solely for illustration and not limitation of the disclosure, and in which:

FIG. 1A illustrates a high-level system architecture of a wireless communications system in accordance with an aspect of the disclosure.

FIG. 1B illustrates a high-level system architecture of a wireless communications system in accordance with another aspect of the disclosure.

FIG. 1C illustrates a high-level system architecture of a wireless communications system in accordance with an aspect of the disclosure.

FIG. 1D illustrates a high-level system architecture of a wireless communications system in accordance with an aspect of the disclosure.

FIG. 1E illustrates a high-level system architecture of a wireless communications system in accordance with an aspect of the disclosure.

FIG. 2A illustrates an exemplary Internet of Things (IoT) device in accordance with aspects of the disclosure, while FIG. 2B illustrates an exemplary passive IoT device in accordance with aspects of the disclosure.

FIG. 3 illustrates a communication device that includes logic configured to perform functionality in accordance with an aspect of the disclosure.

FIG. 4 illustrates an exemplary server according to various aspects of the disclosure.

FIG. 5A illustrates an example of an IoT network in an office environment before onboarding of peer-to-peer devices.

FIG. 5B illustrates an example of the IoT network of FIG. 5A after onboarding of peer-to-peer devices.

FIG. 6 illustrates an example of a process for onboarding a first IoT device to a second IoT device to establish a connection to the IoT network.

FIG. 7 illustrates another example of a process for onboarding a first IoT device to a second IoT device to establish a connection to the IoT network.

FIG. 8 illustrates yet another example of a process for onboarding a first IoT device to a second IoT device to establish a connection to the IoT network.

### DETAILED DESCRIPTION

Various aspects are disclosed in the following description and related drawings to show specific examples relating to exemplary embodiments of onboarding a user device that needs to be connected to a home network but has limited or no user interface capability itself by requesting and receiving permission to onboard from another user device that is already on the home network. Alternate embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term “Internet of Things device” (or “IoT device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

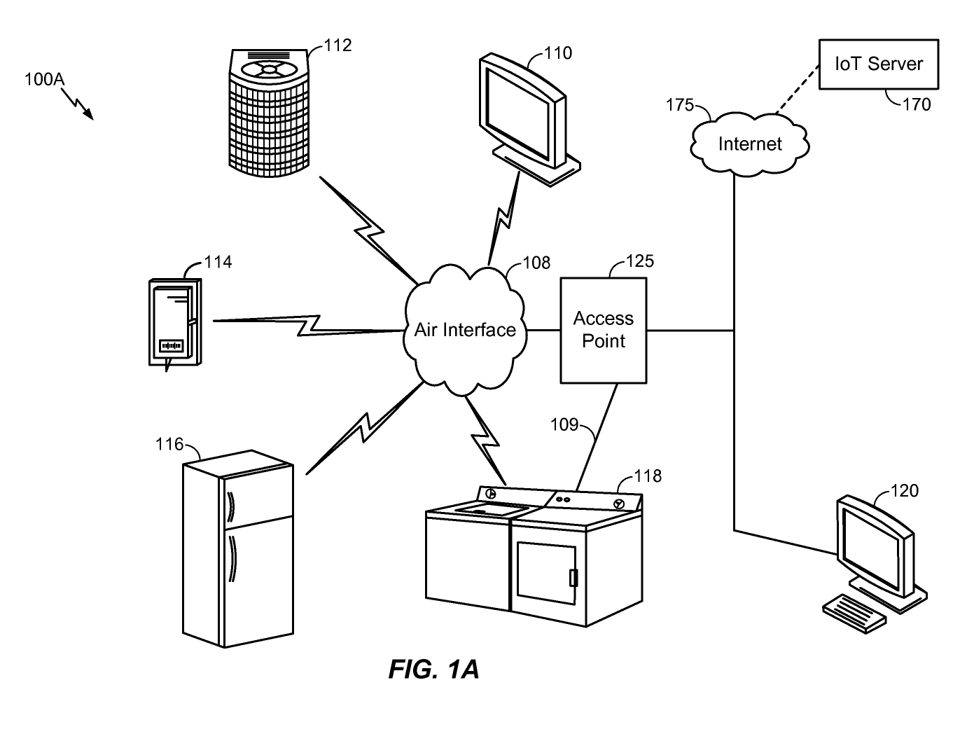

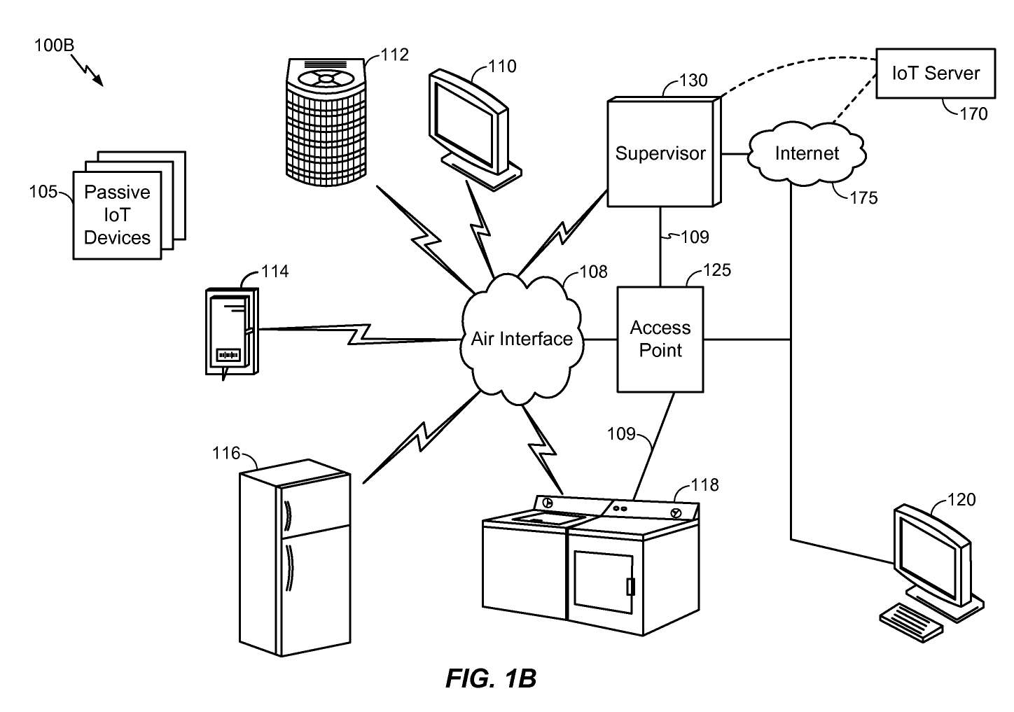

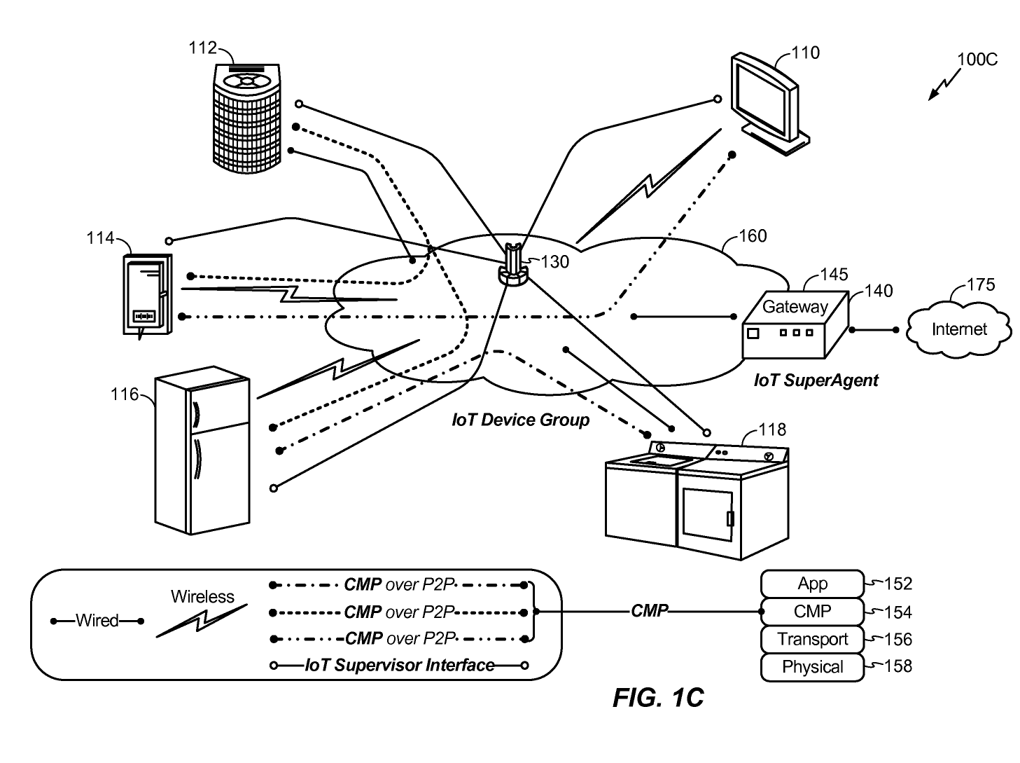

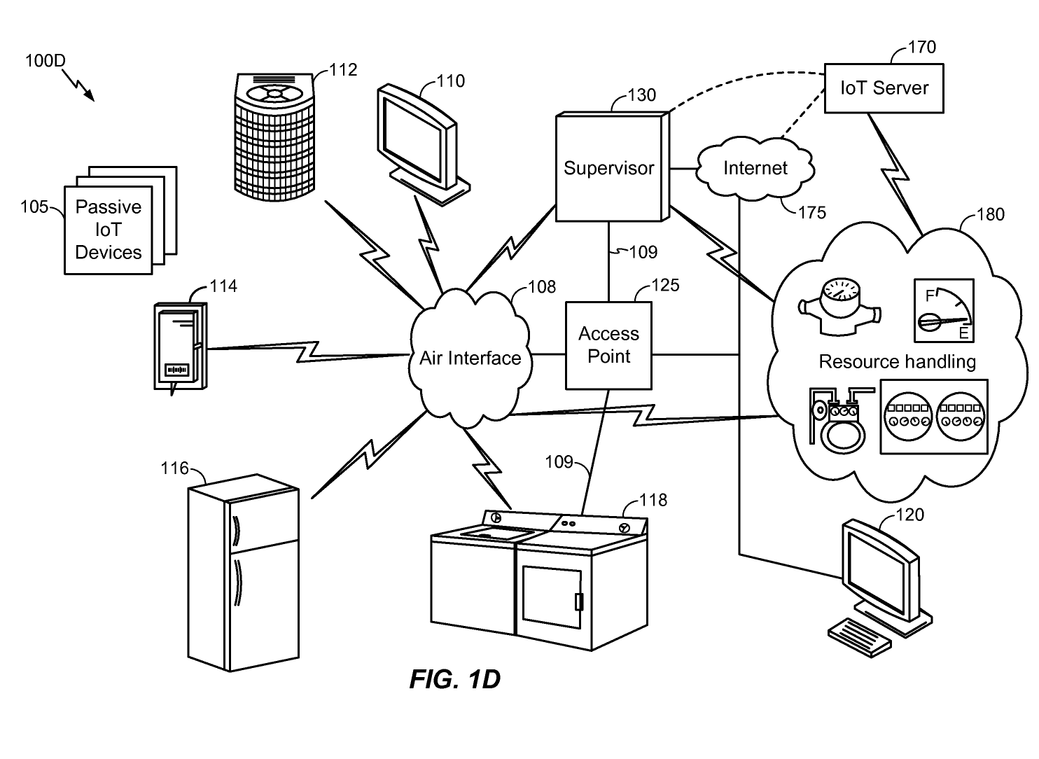

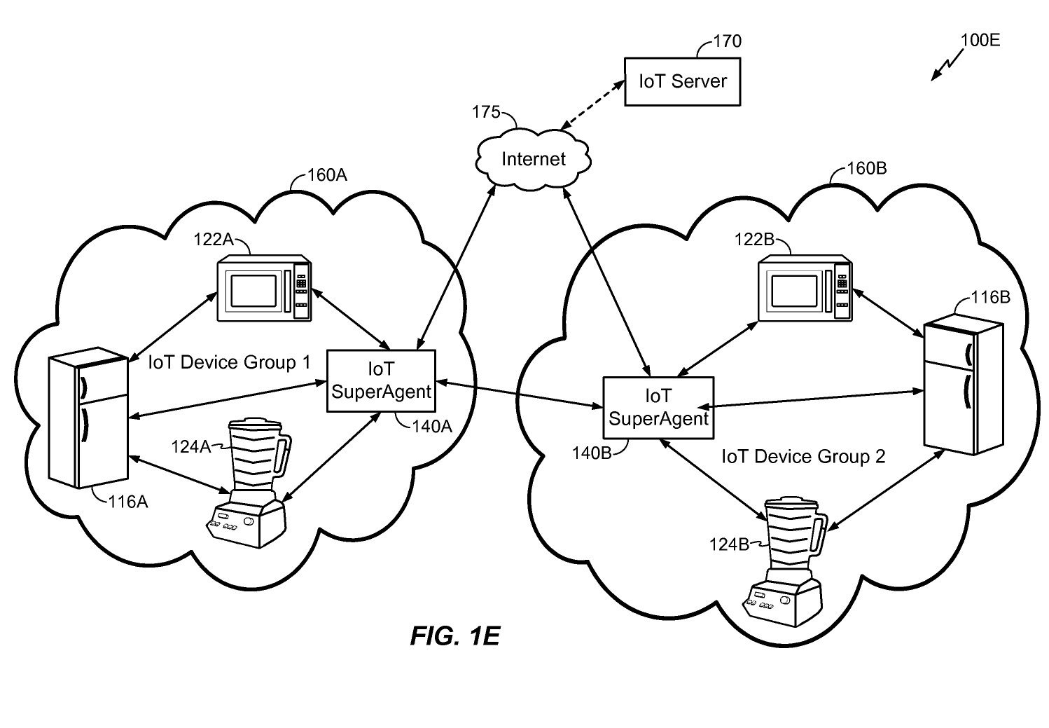

FIG. 1A illustrates a high-level system architecture of a wireless communications system 100A in accordance with an aspect of the disclosure. The wireless communications system 100A contains a plurality of IoT devices, which include a television 110, an outdoor air conditioning unit 112, a thermostat 114, a refrigerator 116, and a washer and dryer 118.

Referring to FIG. 1A, IoT devices 110-118 are configured to communicate with an access network (e.g., an access point 125) over a physical communications interface or layer, shown in FIG. 1A as air interface 108 and a direct wired connection 109. The air interface 108 can comply with a wireless Internet protocol (IP), such as IEEE 802.11. Although FIG. 1A illustrates IoT devices 110-118 communicating over the air interface 108 and IoT device 118 communicating over the direct wired connection 109, each IoT device may communicate over a wired or wireless connection, or both.

The Internet 175 includes a number of routing agents and processing agents (not shown in FIG. 1A for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1A, a computer 120, such as a desktop or personal computer (PC), is shown as connecting to the Internet 175 directly (e.g., over an Ethernet connection or Wi-Fi or 802.11-based network). The computer 120 may have a wired connection to the Internet 175, such as a direct connection to a modem or router, which, in an example, can correspond to the access point 125 itself (e.g., for a Wi-Fi router with both wired and wireless connectivity). Alternatively, rather than being connected to the access point 125 and the Internet 175 over a wired connection, the computer 120 may be connected to the access point 125 over air interface 108 or another wireless interface, and access the Internet 175 over the air interface 108. Although illustrated as a desktop computer, computer 120 may be a laptop computer, a tablet computer, a PDA, a smart phone, or the like. The computer 120 may be an IoT device and/or contain functionality to manage an IoT network/group, such as the network/group of IoT devices 110-118.

The access point 125 may be connected to the Internet 175 via, for example, an optical communication system, such as FiOS, a cable modem, a digital subscriber line (DSL) modem, or the like. The access point 125 may communicate with IoT devices 110-120 and the Internet 175 using the standard Internet protocols (e.g., TCP/IP).

Referring to FIG. 1A, an IoT server 170 is shown as connected to the Internet 175. The IoT server 170 can be implemented as a plurality of structurally separate servers, or alternately may correspond to a single server. In an aspect, the IoT server 170 is optional (as indicated by the dotted line), and the group of IoT devices 110-120 may be a peer-to-peer (P2P) network. In such a case, the IoT devices 110-120 can communicate with each other directly over the air interface 108 and/or the direct wired connection 109. Alternatively, or additionally, some or all of IoT devices 110-120 may be configured with a communication interface independent of air interface 108 and direct wired connection 109. For example, if the air interface 108 corresponds to a Wi-Fi interface, one or more of the IoT devices 110-120 may have Bluetooth or NFC interfaces for communicating directly with each other or other Bluetooth or NFC-enabled devices.

In a peer-to-peer network, service discovery schemes can multicast the presence of nodes, their capabilities, and group membership. The peer-to-peer devices can establish associations and subsequent interactions based on this information.

In accordance with an aspect of the disclosure, FIG. 1B illustrates a high-level architecture of another wireless communications system 100B that contains a plurality of IoT devices. In general, the wireless communications system 100B shown in FIG. 1B may include various components that are the same and/or substantially similar to the wireless communications system 100A shown in FIG. 1A, which was described in greater detail above (e.g., various IoT devices, including a television 110, outdoor air conditioning unit 112, thermostat 114, refrigerator 116, and washer and dryer 118, that are configured to communicate with an access point 125 over an air interface 108 and/or a direct wired connection 109, a computer 120 that directly connects to the Internet 175 and/or connects to the Internet 175 through access point 125, and an IoT server 170 accessible via the Internet 175, etc.). As such, for brevity and ease of description, various details relating to certain components in the wireless communications system 100B shown in FIG. 1B may be omitted herein to the extent that the same or similar details have already been provided above in relation to the wireless communications system 100A illustrated in FIG. 1A.

Referring to FIG. 1B, the wireless communications system 100B may include a supervisor device 130, which may alternatively be referred to as an IoT manager 130 or IoT manager device 130. As such, where the following description uses the term “supervisor device” 130, those skilled in the art will appreciate that any references to an IoT manager, group owner, or similar terminology may refer to the supervisor device 130 or another physical or logical component that provides the same or substantially similar functionality.

In one embodiment, the supervisor device 130 may generally observe, monitor, control, or otherwise manage the various other components in the wireless communications system 100B. For example, the supervisor device 130 can communicate with an access network (e.g., access point 125) over air interface 108 and/or a direct wired connection 109 to monitor or manage attributes, activities, or other states associated with the various IoT devices 110-120 in the wireless communications system 100B. The supervisor device 130 may have a wired or wireless connection to the Internet 175 and optionally to the IoT server 170 (shown as a dotted line). The supervisor device 130 may obtain information from the Internet 175 and/or the IoT server 170 that can be used to further monitor or manage attributes, activities, or other states associated with the various IoT devices 110-120. The supervisor device 130 may be a standalone device or one of IoT devices 110-120, such as computer 120. The supervisor device 130 may be a physical device or a software application running on a physical device. The supervisor device 130 may include a user interface that can output information relating to the monitored attributes, activities, or other states associated with the IoT devices 110-120 and receive input information to control or otherwise manage the attributes, activities, or other states associated therewith. Accordingly, the supervisor device 130 may generally include various components and support various wired and wireless communication interfaces to observe, monitor, control, or otherwise manage the various components in the wireless communications system 100B.

The wireless communications system 100B shown in FIG. 1B may include one or more passive IoT devices 105 (in contrast to the active IoT devices 110-120) that can be coupled to or otherwise made part of the wireless communications system 100B. In general, the passive IoT devices 105 may include barcoded devices, Bluetooth devices, radio frequency (RF) devices, RFID tagged devices, infrared (IR) devices, NFC tagged devices, or any other suitable device that can provide its identifier and attributes to another device when queried over a short range interface. Active IoT devices may detect, store, communicate, act on, and/or the like, changes in attributes of passive IoT devices.

For example, passive IoT devices 105 may include a coffee cup and a container of orange juice each having an RFID tag or barcode. A cabinet IoT device and the refrigerator IoT device 116 may each have an appropriate scanner or reader that can read the RFID tag or barcode to detect when the coffee cup and/or the container of orange juice passive IoT devices 105 have been added or removed. In response to the cabinet IoT device detecting the removal of the coffee cup passive IoT device 105 and the refrigerator IoT device 116 detecting the removal of the container of orange juice passive IoT device, the supervisor device 130 may receive one or more signals that relate to the activities detected at the cabinet IoT device and the refrigerator IoT device 116. The supervisor device 130 may then infer that a user is drinking orange juice from the coffee cup and/or likes to drink orange juice from a coffee cup.

Although the foregoing describes the passive IoT devices 105 as having some form of RFID tag or barcode communication interface, or some form of light, sound or power line communication interface, the passive IoT devices 105 may include one or more devices or other physical objects that do not have such communication capabilities. For example, certain IoT devices may have appropriate scanner or reader mechanisms that can detect shapes, sizes, colors, and/or other observable features associated with the passive IoT devices 105 to identify the passive IoT devices 105. In this manner, any suitable physical object may communicate its identity and attributes and become part of the wireless communication system 100B and be observed, monitored, controlled, or otherwise managed with the supervisor device 130. Further, passive IoT devices 105 may be coupled to or otherwise made part of the wireless communications system 100A in FIG. 1A and observed, monitored, controlled, or otherwise managed in a substantially similar manner.

In accordance with another aspect of the disclosure, FIG. 1C illustrates a high-level architecture of another wireless communications system 100C that contains a plurality of IoT devices. In general, the wireless communications system 100C shown in FIG. 1C may include various components that are the same and/or substantially similar to the wireless communications systems 100A and 100B shown in FIGS. 1A and 1B, respectively, which were described in greater detail above. As such, for brevity and ease of description, various details relating to certain components in the wireless communications system 100C shown in FIG. 1C may be omitted herein to the extent that the same or similar details have already been provided above in relation to the wireless communications systems 100A and 100B illustrated in FIGS. 1A and 1B, respectively.

The communications system 100C shown in FIG. 1C illustrates exemplary peer-to-peer communications between the IoT devices 110-118 and the supervisor device 130. As shown in FIG. 1C, the supervisor device 130 communicates with each of the IoT devices 110-118 through an IoT supervisor interface. Further, IoT devices 110 and 114, IoT devices 112, 114, and 116, and IoT devices 116 and 118, communicate directly with each other.

The IoT devices 110-118 make up an IoT group 160. An IoT device group 160 is a group of locally connected IoT devices, such as the IoT devices connected to a user's home network. Although not shown, multiple IoT device groups may be connected to and/or communicate with each other via an IoT SuperAgent 140 connected to the Internet 175. At a high level, the supervisor device 130 manages intra-group communications, while the IoT SuperAgent 140 can manage inter-group communications. Although shown as separate devices, the supervisor device 130 and the IoT SuperAgent 140 may be, or reside on, the same device (e.g., a standalone device or an IoT device, such as computer 120 in FIG. 1A). Alternatively, the IoT SuperAgent 140 may correspond to or include the functionality of the access point 125. As yet another alternative, the IoT SuperAgent 140 may correspond to or include the functionality of an IoT server, such as IoT server 170. The IoT SuperAgent 140 may encapsulate gateway functionality 145.

Each IoT device 110-118 can treat the supervisor device 130 as a peer and transmit attribute/schema updates to the supervisor device 130. When an IoT device needs to communicate with another IoT device, it can request the pointer to that IoT device from the supervisor device 130 and then communicate with the target IoT device as a peer. The IoT devices 110-118 communicate with each other over a peer-to-peer communication network using a common messaging protocol (CMP). As long as two IoT devices are CMP-enabled and connected over a common communication transport, they can communicate with each other. In the protocol stack, the CMP layer 154 is below the application layer 152 and above the transport layer 156 and the physical layer 158.

In accordance with another aspect of the disclosure, FIG. 1D illustrates a high-level architecture of another wireless communications system 100D that contains a plurality of IoT devices. In general, the wireless communications system 100D shown in FIG. 1D may include various components that are the same and/or substantially similar to the wireless communications systems 100A-C shown in FIGS. 1-C, respectively, which were described in greater detail above. As such, for brevity and ease of description, various details relating to certain components in the wireless communications system 100D shown in FIG. 1D may be omitted herein to the extent that the same or similar details have already been provided above in relation to the wireless communications systems 100A-C illustrated in FIGS. 1A-C, respectively.

The Internet 175 is a “resource” that can be regulated using the concept of the IoT.

However, the Internet 175 is just one example of a resource that is regulated, and any resource could be regulated using the concept of the IoT. Other resources that can be regulated include, but are not limited to, electricity, gas, storage, security, and the like. An IoT device may be connected to the resource and thereby regulate it, or the resource could be regulated over the Internet 175. FIG. 1D illustrates several resources 180, such as natural gas, gasoline, hot water, and electricity, wherein the resources 180 can be regulated in addition to and/or over the Internet 175.

IoT devices can communicate with each other to regulate their use of a resource 180. For example, IoT devices such as a toaster, a computer, and a hairdryer may communicate with each other over a Bluetooth communication interface to regulate their use of electricity (the resource 180). As another example, IoT devices such as a desktop computer, a telephone, and a tablet computer may communicate over a Wi-Fi communication interface to regulate their access to the Internet 175 (the resource 180). As yet another example, IoT devices such as a stove, a clothes dryer, and a water heater may communicate over a Wi-Fi communication interface to regulate their use of gas. Alternatively, or additionally, each IoT device may be connected to an IoT server, such as IoT server 170, which has logic to regulate their use of the resource 180 based on information received from the IoT devices.

Examples of IoT devices in a peer-to-peer network that typically have limited or no user interface capability may include small devices, such as a light emitting diode (LED) light bulb. These devices may also lack direct Internet connectivity. For example, FIG. 1D shows an LED light bulb 111 that is capable of generating a modulated light output with encoded information but has no direct Internet connectivity. In this example, the air interface 108 may be equipped with one or more light sensors capable of receiving modulated light carrying encoded information emitted by the LED light bulb 111. The air interface 108 may be a mobile smartphone, a television set or a mobile hotspot, for example, that is capable of detecting and demodulating/decoding the information-carrying light generated by the LED light bulb 111. In an embodiment, the LED light bulb 111 may be equipped with its own sensor, such as a light sensor, to receive signals from the air interface 108, for onboarding to and receiving commands from the home network, for example. Other IoT devices that have limited or no user interface capability, for example, small appliances such as a coffee maker, may communicate with the air interface 108 by sound, power line networking, visible light or infrared light, for example.

In accordance with another aspect of the disclosure, FIG. 1E illustrates a high-level architecture of another wireless communications system 100E that contains a plurality of IoT devices. In general, the wireless communications system 100E shown in FIG. 1E may include various components that are the same and/or substantially similar to the wireless communications systems 100A-D shown in FIGS. 1-D, respectively, which were described in greater detail above. As such, for brevity and ease of description, various details relating to certain components in the wireless communications system 100E shown in FIG. 1E may be omitted herein to the extent that the same or similar details have already been provided above in relation to the wireless communications systems 100A-D illustrated in FIGS. 1A-D, respectively.

The communications system 100E includes two IoT device groups 160A and 160B. Multiple IoT device groups may be connected to and/or communicate with each other via an IoT SuperAgent connected to the Internet 175. At a high level, an IoT SuperAgent may manage inter-group communications among IoT device groups. For example, in FIG. 1E, the IoT device group 160A includes IoT devices 116A, 122A, and 124A and an IoT SuperAgent 140A, while IoT device group 160B includes IoT devices 116B, 122B, and 124B and an IoT SuperAgent 140B. As such, the IoT SuperAgents 140A and 140B may connect to the Internet 175 and communicate with each other over the Internet 175 and/or communicate with each other directly to facilitate communication between the IoT device groups 160A and 160B. Furthermore, although FIG. 1E illustrates two IoT device groups 160A and 160B communicating with each other via IoT SuperAgents 140A and 140B, those skilled in the art will appreciate that any number of IoT device groups may suitably communicate with each other using IoT SuperAgents.

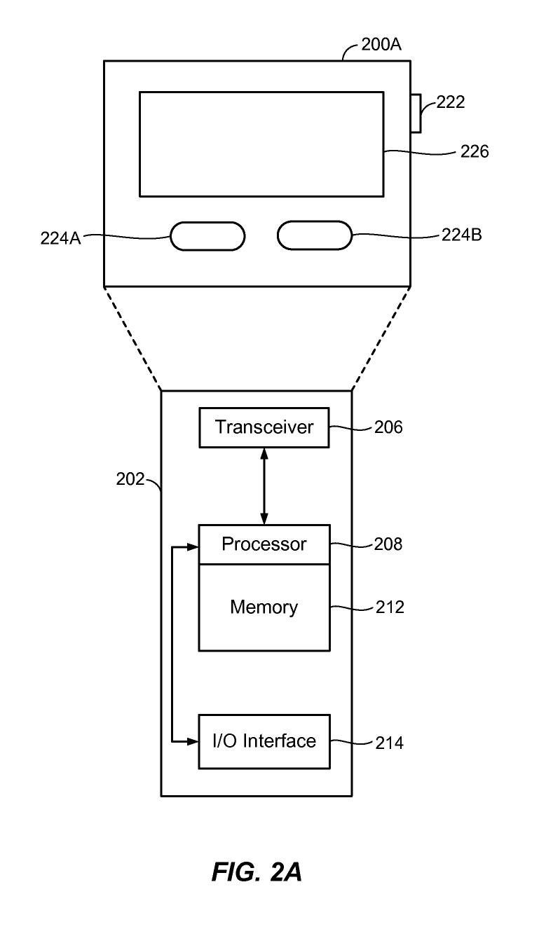

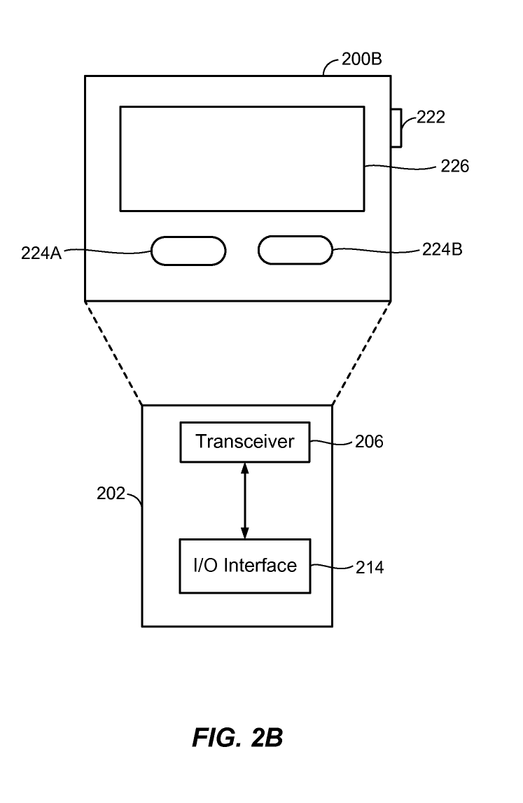

FIG. 2A illustrates a high-level example of an IoT device 200A in accordance with aspects of the disclosure. While external appearances and/or internal components can differ significantly among IoT devices, most IoT devices will have some sort of user interface, which may comprise a display and a means for user input. IoT devices without a user interface can be communicated with remotely over a wired or wireless network, such as air interface 108 in FIGS. 1A-B.

As shown in FIG. 2A, in an example configuration for the IoT device 200A, an external casing of IoT device 200A may be configured with a display 226, a power button 222, and two control buttons 224A and 224B, among other components, as is known in the art. The display 226 may be a touchscreen display, in which case the control buttons 224A and 224B may not be necessary. While not shown explicitly as part of IoT device 200A, the IoT device 200A may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of IoT devices, such as IoT device 200A, can be embodied with different hardware configurations, a basic high-level configuration for internal hardware components is shown as platform 202 in FIG. 2A. The platform 202 can receive and execute software applications, data and/or commands transmitted over a network interface, such as air interface 108 in FIGS. 1A-B and/or a wired interface. The platform 202 can also independently execute locally stored applications. The platform 202 can include one or more transceivers 206 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 208, such as a microcontroller, microprocessor, application specific integrated circuit, digital signal processor (DSP), programmable logic circuit, or other data processing device, which will be generally referred to as processor 208. The processor 208 can execute application programming instructions within a memory 212 of the IoT device. The memory 212 can include one or more of read-only memory (ROM), random-access memory (RAM), electrically erasable programmable ROM (EEPROM), flash cards, or any memory common to computer platforms. One or more input/output (I/O) interfaces 214 can be configured to allow the processor 208 to communicate with and control from various I/O devices such as the display 226, power button 222, control buttons 224A and 224B as illustrated, and any other devices, such as sensors, actuators, relays, valves, switches, and the like associated with the IoT device 200A.

Accordingly, an aspect of the disclosure can include an IoT device (e.g., IoT device 200A) including the ability to perform the functions described herein. As will be appreciated by those skilled in the art, the various logic elements can be embodied in discrete elements, software modules executed on a processor (e.g., processor 208) or any combination of software and hardware to achieve the functionality disclosed herein. For example, transceiver 206, processor 208, memory 212, and I/O interface 214 may all be used cooperatively to load, store and execute the various functions disclosed herein and thus the logic to perform these functions may be distributed over various elements. Alternatively, the functionality could be incorporated into one discrete component. Therefore, the features of the IoT device 200A in FIG. 2A are to be considered merely illustrative and the disclosure is not limited to the illustrated features or arrangement.

FIG. 2B illustrates a high-level example of a passive IoT device 200B in accordance with aspects of the disclosure. In general, the passive IoT device 200B shown in FIG. 2B may include various components that are the same and/or substantially similar to the IoT device 200A shown in FIG. 2A, which was described in greater detail above. As such, for brevity and ease of description, various details relating to certain components in the passive IoT device 200B shown in FIG. 2B may be omitted herein to the extent that the same or similar details have already been provided above in relation to the IoT device 200A illustrated in FIG. 2A.

The passive IoT device 200B shown in FIG. 2B may generally differ from the IoT device 200A shown in FIG. 2A in that the passive IoT device 200B may not have a processor, internal memory, or certain other components. Instead, in one embodiment, the passive IoT device 200B may only include an I/O interface 214 or other suitable mechanism that allows the passive IoT device 200B to be observed, monitored, controlled, managed, or otherwise known within a controlled IoT network. For example, in one embodiment, the I/O interface 214 associated with the passive IoT device 200B may include a barcode, Bluetooth interface, radio frequency (RF) interface, RFID tag, IR interface, NFC interface, or any other suitable I/O interface that can provide an identifier and attributes associated with the passive IoT device 200B to another device when queried over a short range interface (e.g., an active IoT device, such as IoT device 200A, that can detect, store, communicate, act on, or otherwise process information relating to the attributes associated with the passive IoT device 200B).

Although the foregoing describes the passive IoT device 200B as having some form of RF, barcode, or other I/O interface 214, the passive IoT device 200B may comprise a device or other physical object that does not have such an I/O interface 214. For example, certain IoT devices may have appropriate scanner or reader mechanisms that can detect shapes, sizes, colors, and/or other observable features associated with the passive IoT device 200B to identify the passive IoT device 200B. In this manner, any suitable physical object may communicate its identity and attributes and be observed, monitored, controlled, or otherwise managed within a controlled IoT network.

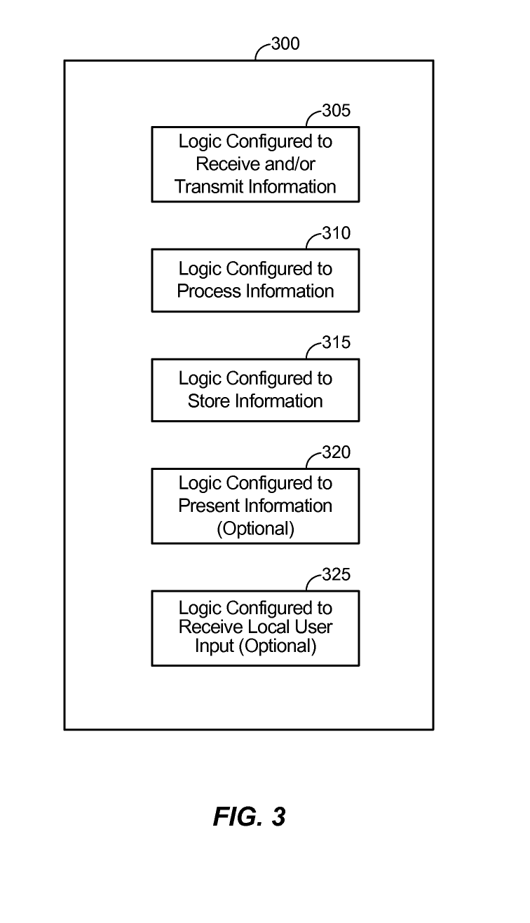

FIG. 3 illustrates a communication device 300 that includes logic configured to perform functionality. The communication device 300 can correspond to any of the above-noted communication devices, including but not limited to IoT devices 110-120, IoT device 200A, any components coupled to the Internet 175 (e.g., the IoT server 170), and so on. Thus, communication device 300 can correspond to any electronic device that is configured to communicate with (or facilitate communication with) one or more other entities over the wireless communications systems 100A-B of FIGS. 1A-B.

Referring to FIG. 3, the communication device 300 includes logic configured to receive and/or transmit information 305. In an example, if the communication device 300 corresponds to a wireless communications device (e.g., IoT device 200A and/or passive IoT device 200B), the logic configured to receive and/or transmit information 305 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the application 170), the logic configured to receive and/or transmit information 305 can correspond to an Ethernet card, in an example, that connects the network-based server to other communication entities via an Ethernet protocol. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the processor included in the logic configured to process information 310 can correspond to a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM, flash memory, ROM, erasable programmable ROM (EPROM), EEPROM, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to the IoT device 200A as shown in FIG. 2A and/or the passive IoT device 200B as shown in FIG. 2B, the logic configured to present information 320 can include the display 226. In a further example, the logic configured to present information 320 can be omitted for certain communication devices, such as network communication devices that do not have a local user (e.g., network switches or routers, remote servers, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to the IoT device 200A as shown in FIG. 2A and/or the passive IoT device 200B as shown in FIG. 2B, the logic configured to receive local user input 325 can include the buttons 222, 224A, and 224B, the display 226 (if a touchscreen), etc. In a further example, the logic configured to receive local user input 325 can be omitted for certain communication devices, such as network communication devices that do not have a local user (e.g., network switches or routers, remote servers, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used throughout this disclosure is intended to invoke an aspect that is at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

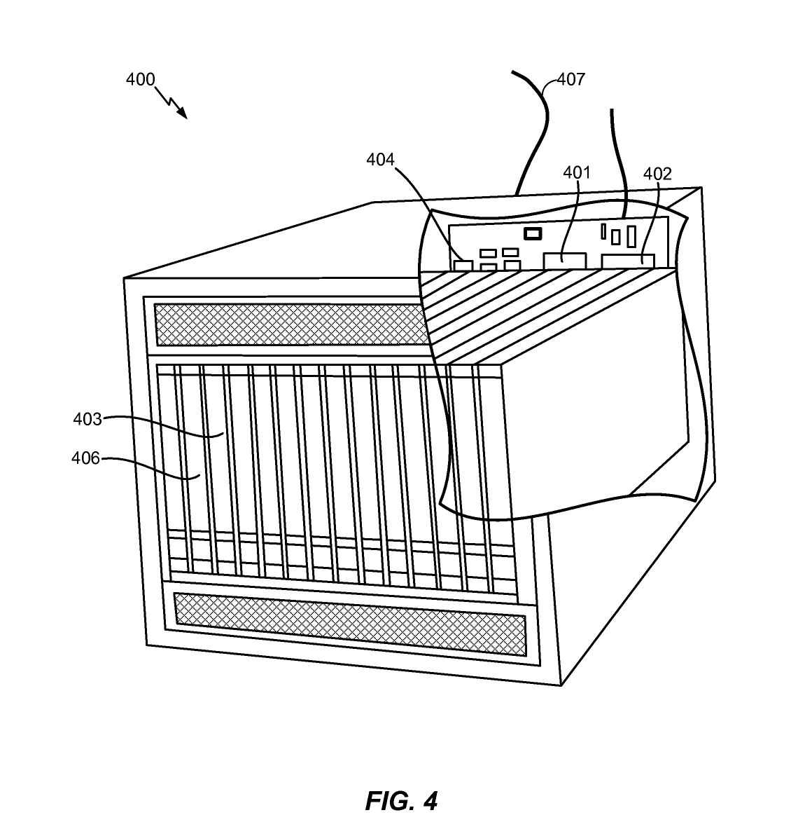

The various embodiments may be implemented on any of a variety of commercially available server devices, such as server 400 illustrated in FIG. 4. In an example, the server 400 may correspond to one example configuration of the IoT server 170 described above. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to transmit and/or receive information 305 corresponds to the network access points 404 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to an IoT device implementation as in FIG. 2A.

In an embodiment, a device that has already been connected to the user's home network is allowed to configure one or more IoT devices that have been plugged in for the first time with minimal user intervention. Some of these IoT devices may have limited or no user interface capability and limited or no direct Internet connectivity. Such IoT devices may include, for example, small appliances such as coffee makers or LED light bulbs. These IoT devices would need to be able to trade information peer-to-peer with the home-network-connected device, such as a smartphone, a TV or a mobile hotspot, for example. In an embodiment, such IoT devices may communicate with the home-network-connected device over any one of various types of communication media, including but not limited to, sound, power line networking, visible light, and infrared light, for example.

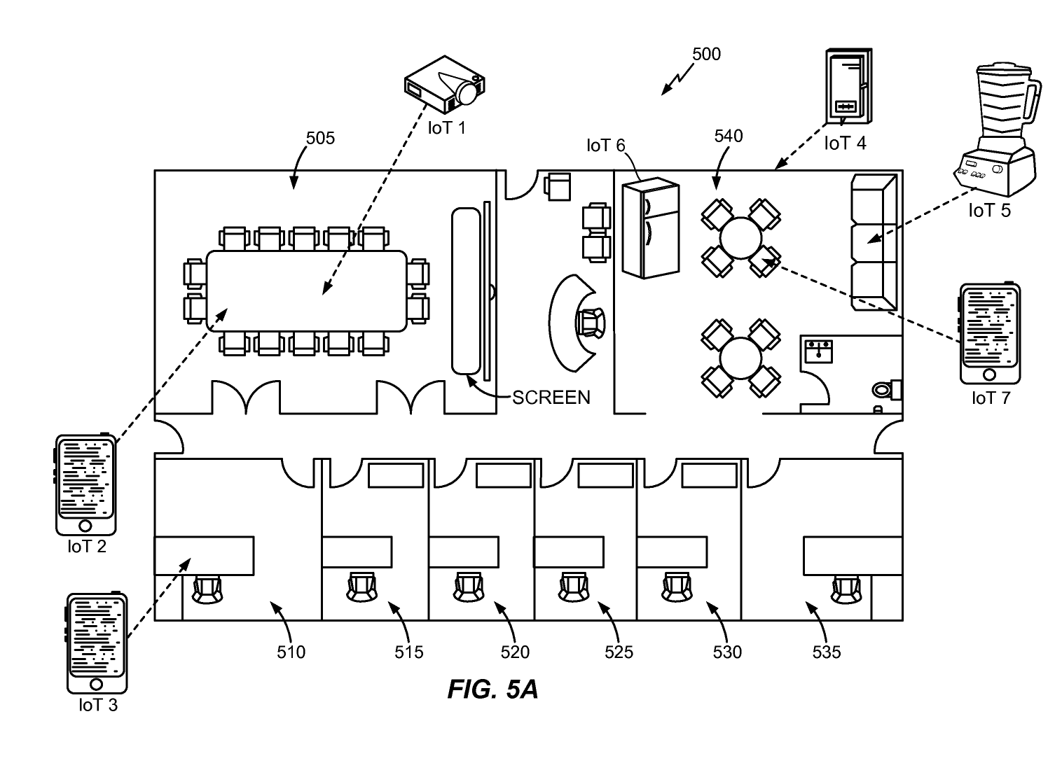

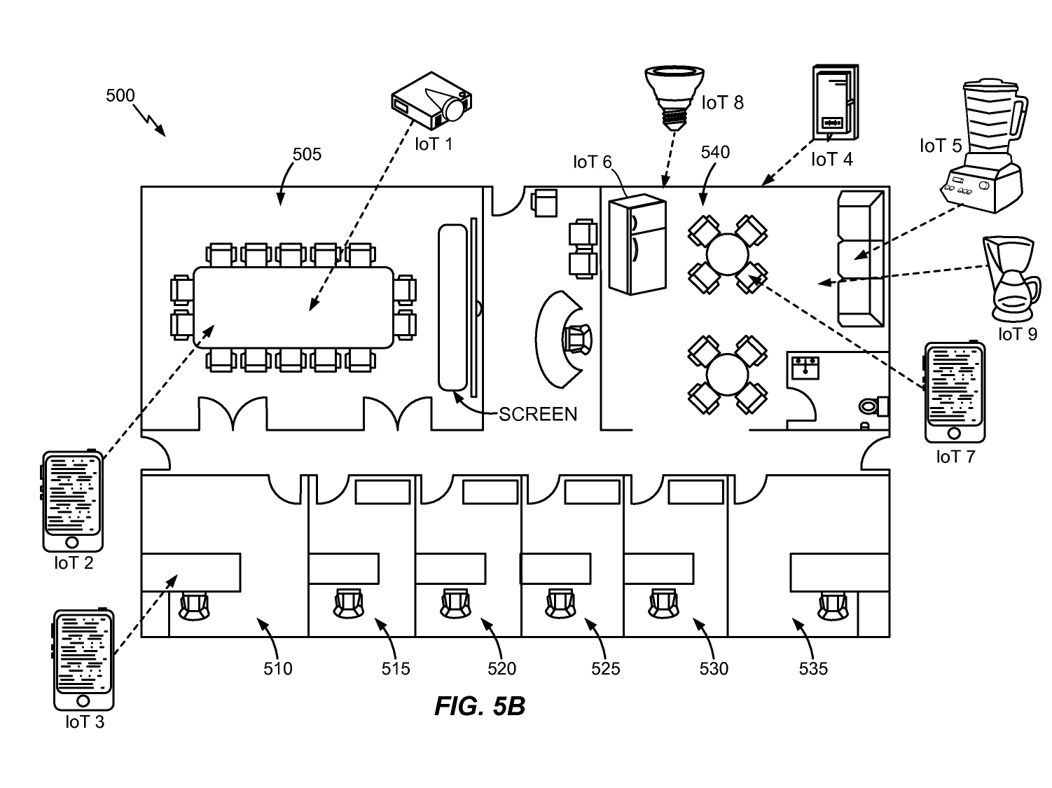

FIG. 5A illustrates an example of a typical IoT environment 500 before onboarding IoT devices that have little or no user interface capability, for example, an LED light bulb or a coffee maker. In FIG. 5, the IoT environment 500 is an office space with a conference room 505, a plurality of offices 510 through 535 and a kitchen 540. Within the office space, IoT device 1 (e.g., a video projector) and IoT device 2 (e.g., a handset device such as a cell phone or tablet computer) are positioned the conference room 505, and IoT device 3 (e.g., a handset device such as a cell phone or tablet computer) is positioned in office 510. Also, IoT device 7 (e.g., a handset device such as a cell phone or tablet computer being operated by an employee on his/her lunch break, or a laptop or desktop computer, or a Wi-Fi or Bluetooth hotspot, or a networked television set) are positioned in the kitchen 540. As will be appreciated, while the IoT environment 500 of FIG. 5 is directed to an office, many other configurations of IoT environments are also possible (e.g., residential homes, retail stores, vehicles, stadiums, etc.).

FIG. 5B illustrates an example of the IoT environment 500 similar to the one illustrated in FIG. 5A, except that IoT devices that have little or no user interface capability, such as IoT device 8 (e.g., a light emitting diode (LED) light bulb) and IoT device 9 (e.g., a coffee maker), have been onboarded through peer-to-peer connections to the network. In the embodiment shown in FIG. 5B, peer-to-peer IoT devices 8 and 9, such as an LED light bulb and a coffee maker, are capable of peer-to-peer connections to another networked IoT device via a communication interface other than conventional types of communication interfaces for wireless networks, such as Wi-Fi or Bluetooth. For example, an LED light bulb, shown as IoT device 8 in FIG. 5B, may be a “smart” light bulb that is capable of generating a modulated light output with encoded information but may have no direct connectivity with Wi-Fi or Bluetooth. In the embodiment shown in FIG. 5B, the IoT device 7, which is already on a Wi-Fi or Bluetooth network, may be equipped with one or more light sensors capable of detecting the light emitted by the LED light bulb. The IoT device 8 may be a mobile smartphone, a tablet, a computer, a television set or a mobile hotspot, for example, that is capable of detecting, demodulating and decoding the information-carrying light generated by the LED light bulb (IoT device 8). In a further embodiment, the LED light bulb (IoT device 8) may be equipped with its own sensor, such as a light sensor, to receive signals from the network-connected IoT device 7, for onboarding to and receiving commands from the network, for example. Other IoT devices that have limited or no user interface capability, for example, small appliances such as a coffee maker, shown as IoT device 9 in FIG. 5B, may communicate with the network-connected IoT device 7 by sound, power line networking, visible light or infrared light, for example.

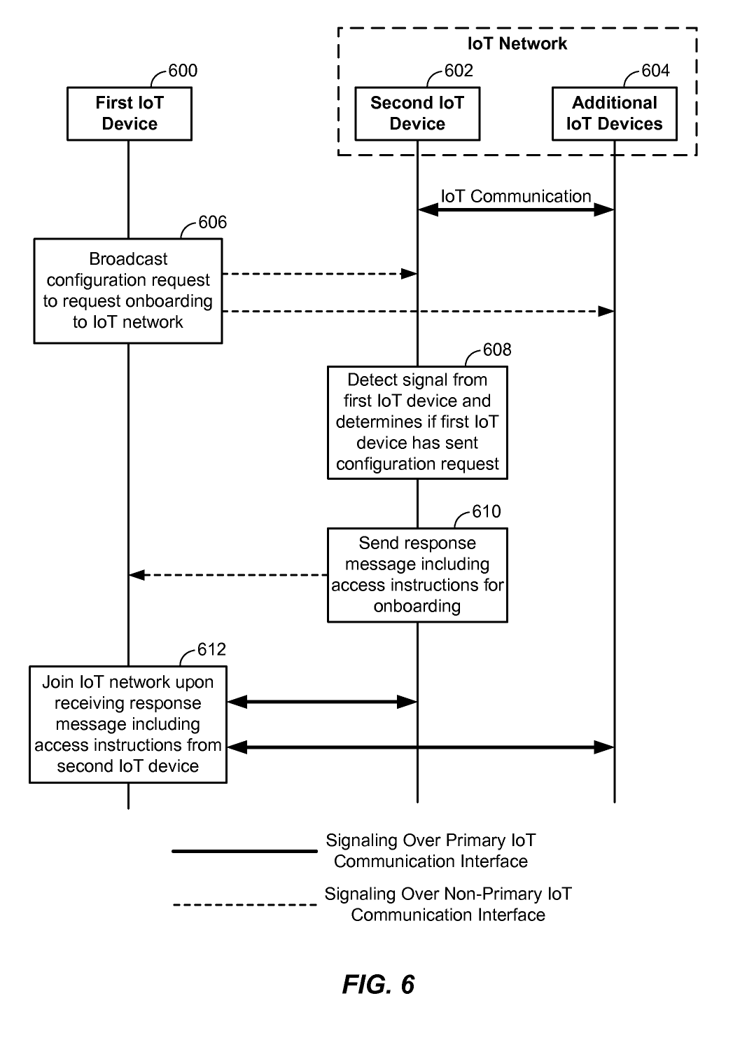

FIG. 6 illustrates an embodiment of a process of onboarding a first IoT device 600, in this example, an LED light bulb, with limited or no user interfacing capability, to a second IoT device 602, such as a mobile phone, a tablet, a computer, a television set, or a Wi-Fi or Bluetooth hotspot. One or more additional IoT devices 604 may also be operating within the IoT network. In the embodiment illustrated in FIG. 6, it is assumed that the second IoT device 602 is the first device operating on the IoT network to detect a configuration request by the first IoT device 600 to onboard to the IoT network. In an embodiment, the first IoT device 600 is able to encode information and transmit output signals carrying the encoded information on a non-primary communication interface 601, that is, an interface other than a primary interface for conventional wireless communications, such as Wi-Fi or Bluetooth, for example. In an embodiment in which the first IoT device 600 is an LED light bulb capable of transmitting modulated visible light carrying encoded information, for example, the light bulb may transmit the information-carrying light to the second IoT device 600, which has a light sensor to detect the light from the LED light bulb and is capable of demodulating, decoding or extracting the information from the detected light. In an embodiment, the second IoT device 602 has wireless connectivity over one or more conventional interfaces, such as a Wi-Fi or Bluetooth interface.

The first IoT device 600 may be any of various home or office electrical devices or appliances with limited or no user interface capability, for example, coffee makers, refrigerators, blenders, as well as light bulbs. Although an example is described above for an LED light bulb capable of transmitting modulated light output carrying encoded information, other types of media may also be used for communication between the first IoT device 600 and the second IoT device 602. For example, in an embodiment in which the first IoT device 600 is a coffee maker, it may communicate with the second IoT device 602 by sound, visible light or infrared light that is modulated with encoded information, provided that the second IoT device 602 is equipped with corresponding sensors and/or receivers capable of detecting the information-carrying sound, visible light or infrared light. In yet another embodiment, the first IoT device 600 may communicate with the second IoT device 602 using a power line connection, through conventional AC power outlets, for example, if both IoT devices 600 and 602 are connected to AC power outlets.

In an embodiment, the first IoT device 600 is also equipped with one or more sensors and/or receivers to allow the first IoT device 600 to receive signals from the second IoT device 602 through one or more communication interfaces or media. Such media may include, for example, sound, visible light, infrared light, or power line connection. For example, in an embodiment in which the first IoT device 600 is an LED light bulb, a small light sensor may be provided on or near the light bulb to receive coded information by sensing modulated light from the second IoT device 602. Similarly, in an embodiment in which the first IoT device 600 is a coffee maker, it may be equipped with a microphone, a visible or infrared light sensor, or a sensor for detecting signals from a power line for receiving commands from the second IoT device 602. The communication media between the first IoT device 600 and the second IoT device 602 may be different from conventional types of media, such as Wi-Fi or Bluetooth, for example.

In the embodiment shown in FIG. 6, the first IoT device 600 may broadcast a “configuration request” message in step 606 over a non-primary communication interface in a type of medium not traditionally associated with conventional networks such as Wi-Fi or Bluetooth networks. For example, in the embodiment in which the first IoT device 600 is an LED light bulb, it may broadcast a “configuration request” by encoding and modulating its light output with data bits representing the “configuration request.” Another device 602 that is already connected to a network, such as a conventional Wi-Fi or Bluetooth network in a home or office environment, for example, detects the light emitted by the LED light bulb and determines if the detected light carries data bits representing a “configuration request” in step 608. If the second IoT device 602 determines that the first IoT device 600 did send a “configuration request” seeking on boarding of the first IoT device 600 to the network, then the second IoT device sends a response message indicating that the first IoT device is permitted to join the IoT network in step 610. In an embodiment, the response message may include a set of connection instructions, such as SSID or passphrase, for the first IoT device 600 to access the IoT network. Various security schemes may be provided to ensure that the first IoT device seeking onboarding to the IoT network is an authorized device in manners known to persons skilled in the art. In the embodiment shown in FIG. 6, the first IoT device 600 detects the response message transmitted by the second IoT device and joins the IoT network using the set of connection instructions given by the second IoT device 602 in step 612.

It will be appreciated that the medium over which the second IoT device 602 transmits a response message with a set of onboarding instruction to the first IoT device 600 may or may not be the same medium over which the first IoT device 600 transmits a “configuration request” to the second IoT device 602. For example, in an embodiment in which the first IoT device 600 is an LED light bulb, the configuration request may be transmitted by the light bulb by modulating the light output, whereas the response message may be received through another type of non-primary communication interface, such as a power line connection, for example. Furthermore, FIG. 6 illustrates an embodiment in which the first IoT device 600 establishes a connection to the IoT network without user intervention.

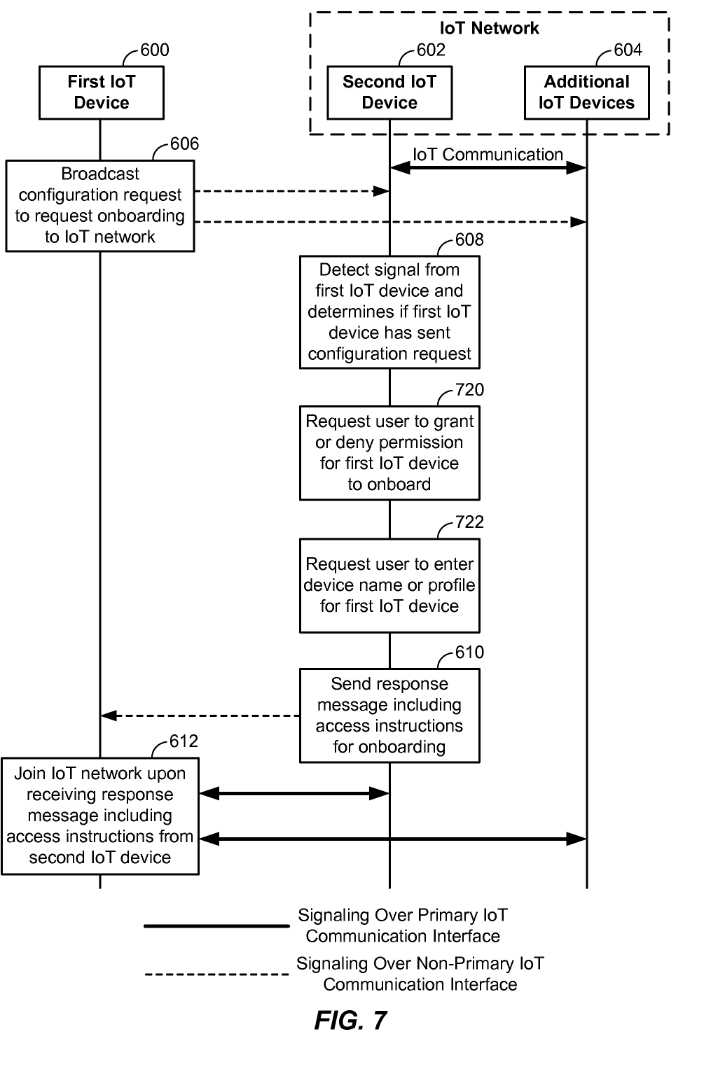

FIG. 7 illustrates an embodiment of an onboarding process similar to FIG. 6, except that the user is able to grant or deny authorization to onboard the first IoT device 600 to the network, and in a further embodiment, has the option of naming or creating a device profile for the first IoT device 600 if the network does not already have a device name or profile for the first IoT device 600. In FIG. 7, the first IoT device 600 broadcasts a configuration request to request onboarding to the IoT network in step 606 through a non-primary communication interface in the same manner as in FIG. 6 and described above. The second IoT device 602 detects the signal from the first IoT device 600 and determines if the first IoT device has sent a configuration request in step 608. Upon determining that the first IoT device 600 did send a configuration request, the second IoT device 602, either directly or through a user application, requests the user to either grant or deny authorization for the IoT device to onboard to the IoT network in step 720. In an embodiment, the second IoT device 602 gives the user an option of naming the first IoT device 600 if the device name for the first IoT device 600 is not already stored in the network, or creating a device profile for the first IoT device 600 in step 722. Upon authorization by the user, the second IoT device sends a responsive message which includes access instructions for onboarding the first IoT device 600 to the network in step 610. Again, security features such as SSID or passphrase, or some authentication scheme may be used to ensure that the first IoT device 600 is permitted to access the IoT network. The first IoT device 600, upon receiving the response message including access instructions from the second IoT device 602, joins the IoT network according to the access instructions in step 612.

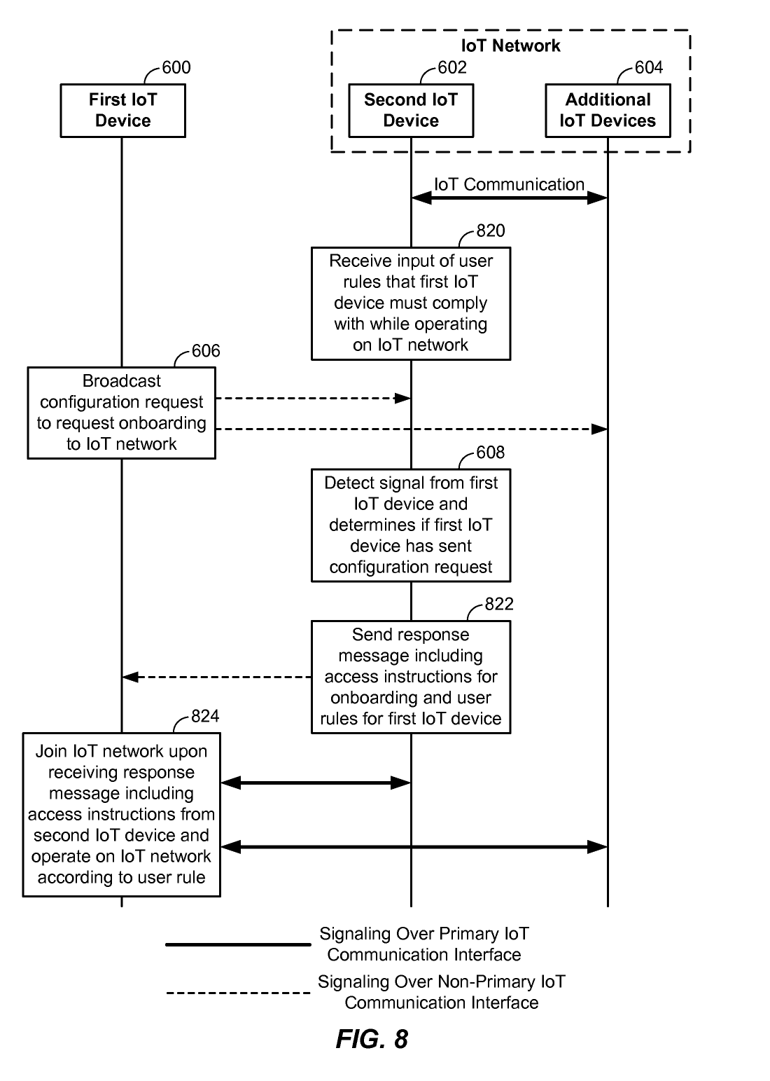

FIG. 8 illustrates yet another embodiment similar to FIGS. 6 and 7, except that a user is allowed to set one or more predetermined rules that the first IoT device 600 must comply with while operating on the IoT network. For example, such predetermined rules may include instructions as to when to power on the first IoT device, the duration of power on, and so on. For example, in an embodiment in which the first IoT device 600 comprises a group of LED light bulbs in a given room, for example, a user may enter rules such as “always allow,” “allow for the next five minutes,” “allow all light bulbs,” or “allow only light bulbs A and B,” and so on. As illustrated in FIG. 8, the second IoT device 602 receives input from the user specifying rules for the first IoT device 600 in step 820 before the second IoT device 602 receives the configuration request broadcast by the first IoT device 600. In an alternate embodiment, the second IoT device 602 may allow the user to input rules for the first IoT device 600 after receiving the configuration request, but before the second IoT device sends a response message allowing the first IoT device 600 to join the network. The second IoT device 602 sends a response message to the first IoT device 600 which includes access instructions for onboarding the first IoT device 600, as well as user-imposed rules that the first IoT device must comply with while operating on the network in step 822. The first IoT device 600 joins the IoT network upon receiving the response message, and operates in accordance with the user-imposed rules while operating within the IoT network in step 824.

In an embodiment, a conventional network onboarding method such as a Wi-Fi-based onboarding method may be used to onboard a device that is provided with Wi-Fi connectivity. For example, a device such as a smartphone, a tablet or TV that needs to be onboarded on a home network may be onboarded by using a conventional Wi-Fi-based method before it is able to onboard other devices such as IoT devices with limited or no user interface capability.

Some IoT devices may have the capability to perform traditional IP-based onboarding as well as peer-to-peer IoT onboarding, for example. When such an IoT device sends a configuration request by peer-to-peer IoT signaling, it also advertises the soft Wi-Fi access point and waits for traditional IP-based onboarding. The first configuration received by the home network, whether through peer-to-peer IoT onboarding request or traditional IP-based Wi-Fi access point advertising, will take priority. For example, if an LED light bulb is capable of both sending a peer-to-peer IOT onboarding request through coded light output and advertising a soft Wi-Fi access point, then whichever request is received by the home network first, whether through coded light output or soft Wi-Fi access point advertising, takes priority. If the configuration request is first received over light, the soft access point will be shut down and abort any onboarding process over IP. If, however, the configuration is received first over IP, the light-based configuration request will be canceled and any data received via light will be disregarded. Once the configuration data is saved, the device will restart and attempt to connect to the stored SSID. Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of onboarding a device, comprising:
detecting a local peer device via an out-of-band communication that is compatible with the device;
communicating with the local peer device to obtain a permission to join a secure network;
receiving access information to access the secure network from the local peer device after an authority has approved the access; and
accessing the secure network using the access information.

2. The method of claim 1, wherein accessing the secure network using the access information comprises accessing the secure network through the local peer device using the access information.

3. The method of claim 1, wherein the authority is granted upon complying with one or more sets of rules to operate the device on the secure network.

4. The method of claim 1, wherein the authority is a user or a device configured by the user to grant or deny access by the device to the secure network.

5. The method of claim 1, wherein the access information comprises one or more passphrases.

6. The method of claim 1, wherein the access information comprises one or more service set identifiers (SSIDs).

7. The method of claim 1, wherein the device comprises an Internet of Things (IoT) device, and wherein the out-of-band communication is over an IoT network.

8. The method of claim 1, wherein the out-of-band communication is made over one or more communication interfaces selected from the group consisting of an optical communication interface, an infrared communication interface, a sound communication interface and a power line communication interface.

9. The method of claim 1, wherein the secure network comprises one or more wireless interfaces.

10. The method of claim 9, wherein said one or more wireless interfaces are selected from the group consisting of a Wi-Fi interface, a Bluetooth interface and a cellular interface.

11. A method for onboarding a device by a local peer device, comprising:
communicating, by the local peer device, with the device via an out-of-band communication that is compatible with the device;
obtaining, by the local peer device, permission from an authority to allow the device to join a secure network; and
transmitting, from the local peer device to the device, access information for the secure network after the authority has approved access to the secure network by the device.

12. The method of claim 11, further comprising relaying information between the device and the secure network through the local peer device.

13. The method of claim 11, wherein the authority is granted upon complying with one or more sets of rules to operate the device on the secure network.

14. The method of claim 11, wherein the authority is a user or a device configured by the user to grant or deny access by the device to the secure network.

15. The method of claim 11, wherein the access information comprises one or more passphrases.

16. The method of claim 11, wherein the access information comprises one or more service set identifiers (SSIDs).

17. The method of claim 11, wherein the device comprises an Internet of Things (IoT) device, and wherein the out-of-band communication is over an IoT network.

18. The method of claim 11, wherein the out-of-band communication is made over one or more communication interfaces selected from the group consisting of an optical communication interface, an infrared communication interface, a sound communication interface and a power line communication interface.

19. The method of claim 11, wherein the secure network comprises one or more wireless interfaces.

20. The method of claim 19, wherein said one or more wireless interfaces are selected from the group consisting of a Wi-Fi interface, a Bluetooth interface and a cellular interface.

21. An Internet of Things (IoT) device, comprising:
means for detecting a local peer device via one or more IoT communication interfaces;
means for communicating with the local peer device to obtain a permission to join a secure network;
means for receiving access information to access the secure network from the local peer device after an authority has approved the access; and
means for accessing the secure network using the access information.

22. The IoT device of claim 21, wherein the means for accessing the secure network using the access information comprises means for accessing the secure network through the local peer device using the access information.

23. The IoT device of claim 21, wherein the authority is granted upon complying with one or more sets of rules to operate the device on the secure network, and wherein the authority is a user or a device configured by the user to grant or deny access by the device to the secure network.

24. The IoT device of claim 21, wherein said one or more IoT communication interfaces are selected from the group consisting of an optical communication interface, an infrared communication interface, a sound communication interface and a power line communication interface.

25. The IoT device of claim 21, wherein the secure network comprises one or more wireless interfaces selected from the group consisting of a Wi-Fi interface, a Bluetooth interface and a cellular interface.

26. A local peer device that is capable of communicating over one or more Internet of Things (IoT) interfaces and over one or more wireless interfaces other than an IoT interface, the local peer device comprising:
means for communicating with an IoT device via said one or more IoT interfaces compatible with the IoT device;
means for obtaining permission from an authority to allow the IoT device to join a secure network; and
means for transmitting to the IoT device access information for the secure network after the authority has approved access to the secure network by the IoT device.

27. The local peer device of claim 26, wherein the authority is granted upon complying with one or more sets of rules to operate the device on the secure network, and wherein the authority is a user or a device configured by the user to grant or deny access by the device to the secure network.

28. The local peer device of claim 26, wherein the access information comprises one or more passphrases or one or more service set identifiers (SSIDs).

29. The local peer device of claim 26, wherein said one or more IoT communication interfaces are selected from the group consisting of an optical communication interface, an infrared communication interface, a sound communication interface and a power line communication interface.

30. The local peer device of claim 26, wherein said one or more wireless interfaces are selected from the group consisting of a Wi-Fi interface, a Bluetooth interface and a cellular interface.
